(19) United States
(12) Patent Application Publication
(10) Pub. No.: US 2003/0133042 A1
(43) Pub. Date: Jul. 17, 2003

(54) Apparatus for and method of processing closed caption

(75) Inventors: Cheon-Seong Lee, Gyeonggi-do (KR); Yong-Woo Lee, Seoul (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/247,281

(22) Filed: Sep. 20, 2002

(30) Foreign Application Priority Data
Jan. 17, 2002 (KR) 2002-2745

(51) Int. Cl. G06F 3/00; H04N 5/445; G06F 13/00; H04N 7/00; H04N 11/00

(52) U.S. Cl. 348/468; 348/563

(57) ABSTRACT

An apparatus for and a method of processing closed captions which encodes and stores the closed captions and video of a broadcast signal as data corresponding to one image. A caption ON/OFF signal enables a viewer to select whether data corresponding to the one image will be stored or data corresponding to only the video of the broadcast signal will be stored. A caption signal display ON/OFF signal provided by a controller initiates reproduction of the stored data to display the one image or to display an image corresponding to the video of the broadcast signal. The apparatus and method conveniently provide for a user to store data corresponding to a closed caption signal and data corresponding to the video of a broadcast signal as optical data on an optical recording medium and to reproduce and display the video of the broadcast signal with or without the closed caption.

### CROSS REFERENCE TO RELATED APPLICATIONS

This application claims the benefit of Korean Application No. 2002-2745, filed Jan. 17, 2002, in the Korean Intellectual Property Office, the disclosure of which is incorporated herein by reference.

### BACKGROUND OF THE INVENTION

1. Field of the Invention

The present invention relates to an apparatus for and method of processing closed captions, and more particularly, to an apparatus for and method of processing closed captions which stores/reproduces a caption signal on/from an optical recording medium by coding the caption signal into a graphic signal and encoding the graphic signal and video of a broadcast signal into data reproducible as one image.

2. Description of the Related Art

An extra service of captioning broadcast for television depicts voice and motion on the television via captions for foreign language learners and the hearing impaired. Captions do not appear on ordinary television receivers; rather the captions appear on televisions having the caption feature or connected with a VCR having the caption feature. Accordingly, captioning is called closed caption.

In the United States, English caption service started in 1972 for the hearing impaired. Since 1990, Federal regulations have required that television receivers over 13 inches in size have captioning capability; and since July 1993, the Federal regulations have required that television broadcasts includes captions.

In the case of Korea, Arirang TV, which is a foreign language channel provided on a cable broadcast system, has imported the US caption broadcast standard, namely EIA-608, for English caption broadcast for a limited number of programs since March 1997. Telecommunications Technology Association (TTA) completed a provisional standard for a peculiar domestic TV caption broadcast having English captioning capability in 1997.

According to the provisional standard, in a Korean caption broadcast, a foreign language caption signal is imposed on scanning line 21 and a Korean caption and character signal are imposed on scanning line 284. In this case, scanning lines 21 and 284 do not contain other signals. Consequently, a viewer having a TV receiver with the Korean captioning feature may selectively use either the foreign language caption service or the Korean caption service through just one TV receiver.

Technology for receiving and displaying closed caption signals has been introduced, but technology for recording the closed caption signals is not yet available. If the selected captioning cannot be recorded, viewers will be inconvenienced.

### SUMMARY OF THE INVENTION

To solve the above-described problem, an object of the present invention is to provide an apparatus for processing closed captions which stores/reproduces a caption signal on/from an optical recording medium by coding the caption signal into a graphic signal and encoding the graphic signal and video signals of the broadcast signal as data corresponding to one image.

Another object of the present invention is to provide a method of processing closed captions which stores/reproduces a caption signal of a broadcast signal on/from an optical recording medium by coding the caption signal into a graphic signal and encoding the graphic signal and video signals of the broadcast signal into data corresponding to one image.

Additional objects and advantages of the invention will be set forth in part in the description which follows, and, in part, will be obvious from the description, or may be learned by practice of the invention.

To accomplish the above and other objects of the invention, an apparatus for processing captions comprises a first signal processor which separates a caption signal from an input broadcast signal to code the caption signal into a graphic signal, a second signal processor which encodes the graphic coded caption signal and a video signal of the broadcast signal into data corresponding to one image and stores the encoded data on an optical recording medium, and a third signal processor which decodes the data stored on the optical recording medium and converts the stored data into a signal to be displayed.

The second signal processor may receive an external caption storing ON/OFF signal to encode the graphic coded caption signal and the video of the broadcast signal into data corresponding to one image, or the second signal processor may encode only the video of the broadcast signal into the data to be stored, and then store the encoded data on the optical recording medium.

The third signal processor may receive an external caption display ON/OFF signal and in response may process both the video of the broadcast signal and the graphic caption signal or may process only the video of the broadcast signal stored on the optical recording medium.

To accomplish the above and other objects of the invention, a method of processing captions comprises separating a caption signal from an input broadcast signal to code the caption signal into a graphic signal, encoding the graphic coded caption signal and video of the broadcast signal into data corresponding to one image to record the encoded data on an optical recording medium, and decoding the encoded data stored on the optical recording medium to display the decoded video of the broadcast signal and the graphic caption signal.

The encoding of the graphic caption signal and the video of the broadcast signal may further comprise receiving an external caption storing ON/OFF signal to encode the graphic coded caption signal and the video of the broadcast signal into the data corresponding to the one image and to store the encoded data on the optical recording medium in response to the caption storing ON signal, or to encode only the video of the broadcast signal to store the encoded data on the recording medium in response to the caption storing OFF signal.

The decoding of the data stored on the optical recording medium may further comprise receiving an external caption display ON/OFF signal to decode the stored data and output the video of the broadcast signal and the graphic caption signal in response to the caption display ON signal, or to decode the stored data to output only the video of the broadcast signal in response to the caption display OFF signal.

### BRIEF DESCRIPTION OF THE DRAWINGS

The above and other objects and advantages of the present invention will become more apparent by describing in detail embodiments thereof with reference to the attached drawings in which:

FIG. 1 is a block diagram illustrating a configuration of an apparatus for processing closed captions, according to the present invention; and

FIG. 2 is a flowchart illustrating a method of processing closed captions, according to the present invention.

### DESCRIPTION OF THE PREFERRED EMBODIMENTS

Reference will now be made in detail to the present embodiments of the present invention, examples of which are illustrated in the accompanying drawings, wherein like reference numerals refer to like elements throughout.

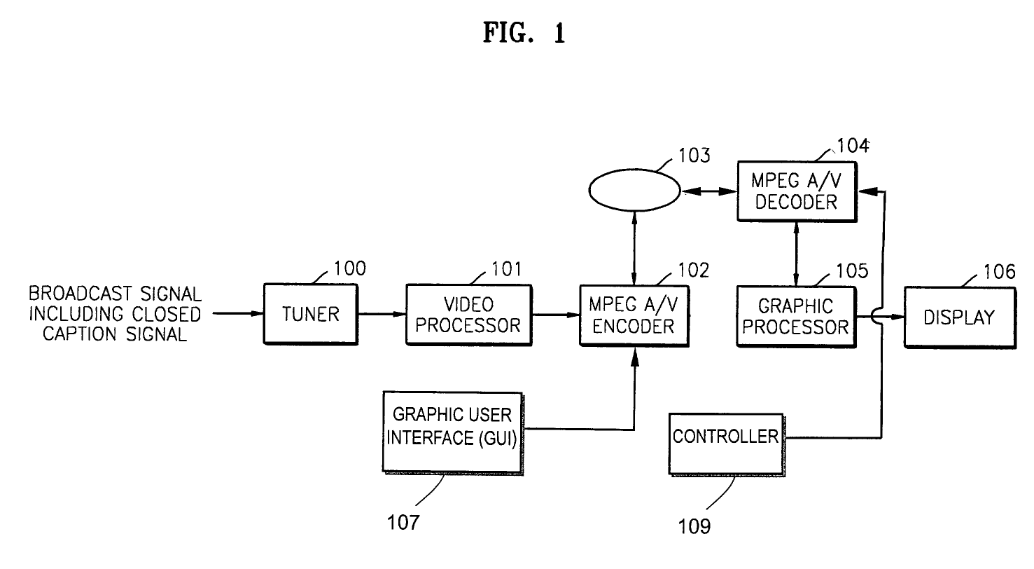

FIG. 1 is a block diagram illustrating a configuration of an apparatus for processing closed captions, according to the present invention. The apparatus for processing closed captions comprises a tuner 100 which tunes a selected broadcast signal, a video processor 101 which separates a closed caption signal from the tuned broadcast signal in order to code the closed caption signal as a graphic signal, a motion pictures experts group (MPEG) audio/video (AN) encoder 102 which encodes the video signal of the broadcast signal and the graphic coded closed caption signal into data corresponding to one image, a disk 103 which stores the encoded data, an MPEG AN decoder 104 which decodes the encoded data stored on the disk 103 to provide an image signal, a graphic processor 105 which processes the image signal to display the one image, and a display 106 which displays the one image.

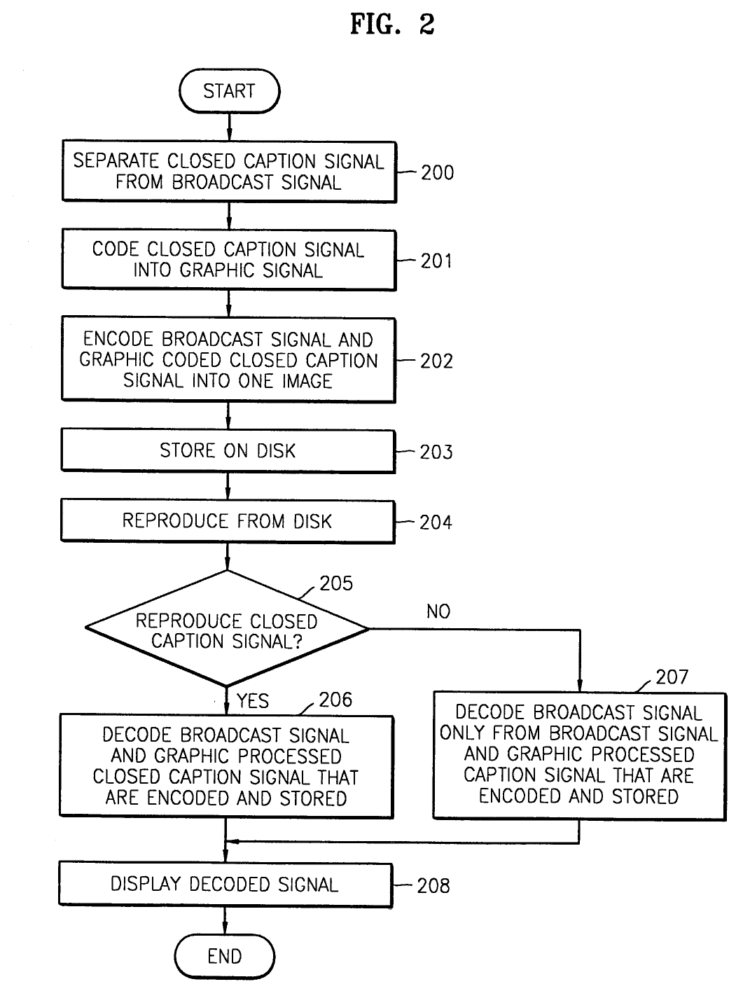

FIG. 2 is a flowchart illustrating a method of processing closed captions, according to the present invention. The method of processing closed captions comprises separating the closed caption signal from the broadcast signal in operation 200, coding the closed caption signal into a graphic signal in operation 201, encoding video of the broadcast and the graphic coded closed caption signals into data corresponding to one image in operation 202, storing the encoded data on the disk in operation 203, reproducing the data corresponding to the one image from the disk in operation 204, determining whether to reproduce the closed caption signal in operation 205, decoding the data stored on the disk in operation 206 to output the video of the broadcast signal and the graphic coded closed caption signals if it is determined that the recorded data includes the graphic coded closed caption signals and in decoding the data stored on the recording medium to output only the video of the broadcast signal at operation 207 if it is determined that the recorded data does not include the graphic coded closed caption signal, and displaying the signal output at operation 206 or operation 207 in operation 208.

The present invention will be described in more detail referring to FIGS. 1 and 2. In order to process closed captions, the broadcast signal is processed to separate the closed caption signal from the selected broadcast signal in operation 200.

The tuner 100 tunes the broadcast signal, which includes the closed caption signal. The video processor 101, which will be referred to as a first signal processor, separates the caption signals imposed on lines 21 and 284 of the tuned broadcast signal. In this case, lines 21 and 284 of the tuned broadcast signal contain only signals relating to the closed caption. The separated closed caption signal is coded into the graphic signal in operation 201.

The video processor 101 codes the closed caption signal, which is separated from lines 21 and 284 of the broadcast signal, into the graphic signal. The video of the broadcast signals and the graphic coded closed caption signals are encoded into data corresponding to one image in operation 202, by the MPEG ANV encoder 102, which will be referred to as a second signal processor. The encoded data is stored on the disk 103 in operation 203.

In storing the encoded data on the disk 103, a viewer may decide whether to store the encoded closed caption signal by using a caption storing ON/OFF signals through a graphic user interface (GUI) 107. Where the caption storing ON signal is selected by the viewer, the closed caption signal and the video of the broadcast signal are encoded into the data corresponding to the one image and stored on the disk 103. Where the viewer selects the caption storing OFF signal, only the data corresponding to the video of the broadcast signal is stored on the disk 103.

After the data is stored on the disk 103, the viewer reproduces the data from the disk 103 in operation 204.

In this case, reproduction of the closed caption signal stored on the disk 103 is decided in operation 205. The decision is performed in a controller 109 for the case where the disk 103 includes data corresponding to the closed caption signal and the video of the broadcast signal. In the case where the disk 103 includes only the video of the broadcast signal, operation 205 is skipped and operation 207 is executed.

In order to reproduce the closed caption signal stored on the disk 103, the video of the broadcast signal and the graphic coded closed caption signal that are encoded and stored on the disk 103 are decoded in operation 206.

The MPEG AN decoder 104 decodes the signals that are encoded into the one image and stored on the disk 103. In order not to reproduce the closed caption signal stored on the disk 103, only the broadcast signal is decoded in operation 207. After completing the decoding, the decoded signal is processed and output to the display 106 in operation 208.

The decoded video of the broadcast signal and the closed caption signal or the decoded broadcast signal are processed in the graphic processor 105 to generate a processed signal which is displayable. Then, the processed signal is output to the display 106. The MPEG AN decoder 104 and the graphic processor 105 will be referred to as a third signal processor.

As a result, the present invention conveniently provides for a user requiring closed captioning by storing a closed caption signal on an optical recording medium for coding into one image and displaying the coded closed caption signal.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus for processing captions comprising:
a first signal processor which separates a caption signal from an input broadcast signal and encodes the caption signal into a graphic signal;
a second signal processor which encodes the graphic coded caption signal and video of the broadcast signal into data corresponding to one image and stores the encoded data on an optical recording medium; and
a third signal processor which decodes the data stored on the optical recording medium and converts the data corresponding to the one image into a signal to be displayed.

2. The apparatus for processing captions of claim 1, wherein the second signal processor encodes the graphic coded caption signal and the video of the broadcast signal into the data corresponding to the one image and stores the encoded data on the optical recording medium in response to an ON state of an external caption storing ON/OFF signal.

3. The apparatus for processing captions of claim 1, wherein the third signal processor converts the decoded stored data to the one image in response to an ON state of an external caption display ON/OFF signal.

4. A method of processing captions comprising:
separating a caption signal from an input broadcast signal to code the caption signal into a graphic signal;
encoding the graphic coded caption signal and video of the broadcast signal into data corresponding to one image;
storing the encoded data on an optical recording medium; and
decoding the stored data corresponding to the one image from the optical recording medium to display the one image.

5. The method of claim 4, wherein the encoding of the graphic coded caption signal and the video of the broadcast signal into the data corresponding to the one image comprises:
receiving an external caption storing ON/OFF signal to encode the graphic coded caption signal and the video of the broadcast signal into the data corresponding to the one image, and
storing the encoded data on the optical recording medium in response to an ON state of the caption storing ON/OFF signal.

6. The method of claim 4, wherein the decoding of the stored data corresponding to the one image comprises:
decoding the data corresponding to the one image in response to an ON state of an external caption display ON/OFF signal.

7. An apparatus for processing captions comprising:
a first signal processor which separates a caption signal from an input broadcast signal and encodes the caption signal into a graphic signal; and
a second signal processor which:
encodes the graphic encoded caption signal and a video signal of the broadcast signal as first data which is reproducible as one image in response to an ON state of a caption storing ON/OFF signal,
encodes the video signal of the broadcast signal as second data in response to an OFF state of the caption storing ON/OFF signal, and
stores one of the encoded first data and the encoded second data on an optical recording medium according to the state of the caption storing ON/OFF signal.

8. The apparatus of claim 7, further comprising:
a third signal processor which:
decodes the first data to display an image corresponding to the video signal of the broadcast signal in response to an OFF state of a caption display ON/OFF signal.

9. The apparatus of claim 7, further comprising:
a third signal processor which:
decodes the first data to display the graphic encoded caption signal and the video signal of the broadcast signal as one image in response to an ON state of a caption display ON/OFF signal.

10. The apparatus of claim 7, further comprising:
a controller which determines whether the first data is stored on the optical recording medium; and
a third signal processor which:
decodes the second data to display the video signal of the broadcast signal where the controller determines that the first data is not stored on the optical recording medium.
